(19) United States
(12) Patent Application Publication
(10) Pub. No.: US 2016/0040766 A1
(43) Pub. Date: Feb. 11, 2016

(54) LINEAR ACTUATOR

(71) Applicant: LINAK A/S, Nordborg (DK)

(72) Inventors: Zhongzheng LIU, Shenzhen (CN); Liyong Jiang, Shenzhen (CN)

(73) Assignee: LINAK A/S, Nordborg (DK)

(21) Appl. No.: 14/801,419

(22) Filed: Jul. 16, 2015

(30) Foreign Application Priority Data
Jul. 16, 2014 (DK) PA 2014 00387

(51) Int. Cl. F16H 25/20

(52) U.S. Cl. CPC F16H 25/20; F16H 2025/209

(57) ABSTRACT

A linear actuator with a support that includes a bearing support frame, a bearing, a worm wheel, and a spindle, the bearing support frame being configured to support and secure the bearing, the bearing being configured to support the worm wheel and riveted to the worm wheel and the spindle; and the worm wheel and the spindle are riveted. The present invention enables the actuator to run more stably and at least doubles the service life of the product; reduces the requirement of the precision of parts such as motor housing and back fixture, and ensures that the service life of the product meet requirements even when the dimension of a few parts is inaccurate; and therefore eliminates the abnormal noise generated by the spindle of the actuator.

### TECHNICAL FIELD OF THE INVENTION

The present invention relates to a linear actuator with a support device.

### BACKGROUND OF THE INVENTION

Currently available linear actuators which are used to support a load come in two structural variations. In the first structure, the components on the spindle, including the worm wheel, are assembled by riveting or screwing, and therefore the worm wheel needs to transfer torque and ensure that the engagement position with the worm shaft remains unchanged. In this way, in case of a high load, the requirements on the strength and precision of the back fixture and the motor housing are very high. In addition, because a large number of parts are involved, it is difficult to control the product quality, thereby increasing the production cost and result in unstable quality.

In the second structure, the spindle components are separated from the worm wheel. In this case, the spindle is responsible for transferring linear movement, and the worm wheel is responsible for transferring torque. This makes full use of the properties of the parts. However, because the unit price of the parts are high, the overall cost is high.

In addition, the support devices for actuators in the prior art are of complex structure and require highly accurate dimensions. In this way, it is difficult to deliver stable quality in case of mass production, leading to high requirements on the production processes and technologies and therefore high production costs.

### SUMMARY OF THE INVENTION

The object of the present invention is to provide a stable and endurable support device for an actuator to lower precision tolerances of the parts and reduce production costs,

Therefore, the present invention provides a support device for an actuator, including a bearing support frame, a bearing, a worm wheel, and a spindle, where the bearing support frame is configured to support and secure the bearing; the bearing is configured to support the worm wheel and riveted to the worm wheel and the spindle; and the worm wheel and the spindle are riveted.

The bearing support frame is configured to support and secure the bearing so as to meet the requirement on the assembly dimensions of the bearing and therefore improve operational stability and extend the service life of the actuator system. The worm wheel and the spindle are assembled and then riveted to make a sub-assembly of the worm wheel and the spindle, so as to increase the fit clearance between the worm wheel and the spindle and make it possible for the worm wheel to deal with torque only. The bearing is assembled to the riveted worm wheel and spindle and then installed on the bearing support frame, this makes it possible to support the front end and rear end of the worm wheel, so as to improve the movement stability of the actuator system and reduce noises.

A further improvement of the present invention is that a coupling is disposed to support a worm wheel, where the coupling transfers the torque of the worm wheel to a spindle and is riveted to the spindle.

A further improvement of the present invention is that a ball bearing is disposed to support a spindle and transfer load, where the ball bearing is riveted to the spindle.

A further improvement of the present invention is that a back fixture is disposed, where the back fixture connects to the ball bearing.

A further improvement of the present invention is that a spindle nut is disposed, where the spindle nut is threadingly engaged with a spindle.

A further improvement of the present invention is that a motor housing is secured onto the motor of the actuator and the bearing is installed inside the motor housing. Preferably, the motor housing is screwed onto the motor.

A further improvement of the present invention is that the back fixture connects to the ball bearing.

A further improvement of the present invention is that an outer tube is secured onto the motor housing. Preferably, the outer tube is screwed onto the motor housing.

Compared with the prior art, the benefits of the present invention are as follows: The actuator will run more stably and the service life of the product will at a minimum double; the tolerance requirements for the parts such as motor housing and back fixture are reduced, and the service life of the product will meet customer requirements even when the dimension of a few parts is inaccurate; and abnormal noise generated by the spindle will be eliminated,

The invention will be better understood by reference to the attached drawings.

### BRIEF DESCRIPTION OF THE DRAWINGS

FIG. 1 is a side view of a first embodiment of the present invention;

FIG. 2 is a view of a bearing support frame in the embodiment in FIG. 1;

FIG. 3 is a view of the bearing in the embodiment in FIG. 1;

FIG. 4 is a cross-sectional view of the bearing;

FIG. 5 is a view of a worm wheel in the embodiment in FIG. 1;

FIG. 6 is a side view of the spindle in the FIG. 1 embodiment;

FIG. 7 is a view of the bearing support frame and the bearing in the embodiment of FIG. 1;

FIG. 8 is a view of the coupling according in the FIG. I embodiment; and

FIG. 9 is a cross-sectional view of a linear actuator according to the invention,

### DETAILED DESCRIPTION OF THE DRAWINGS

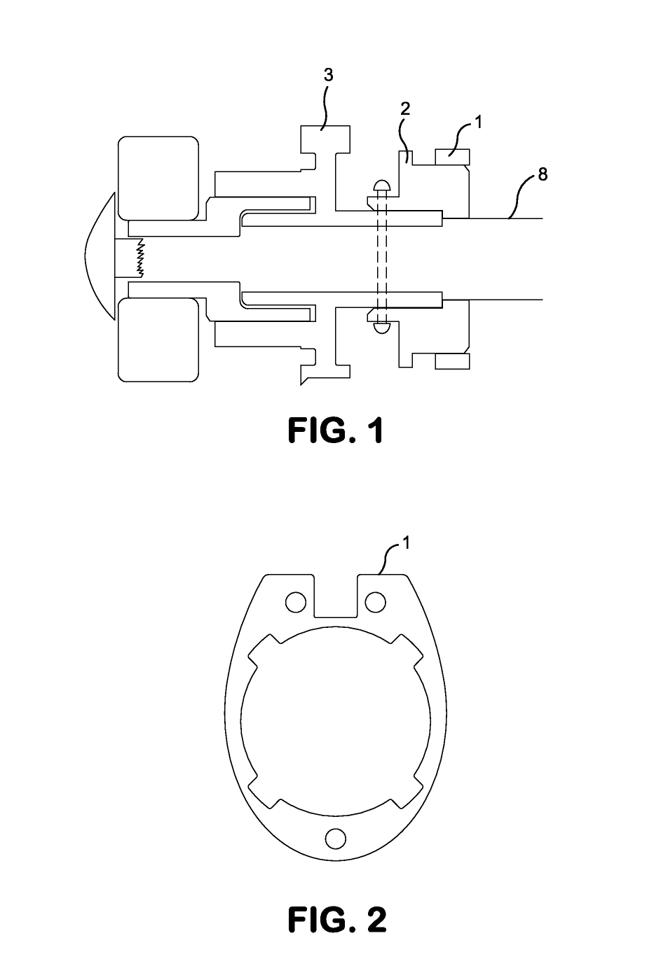

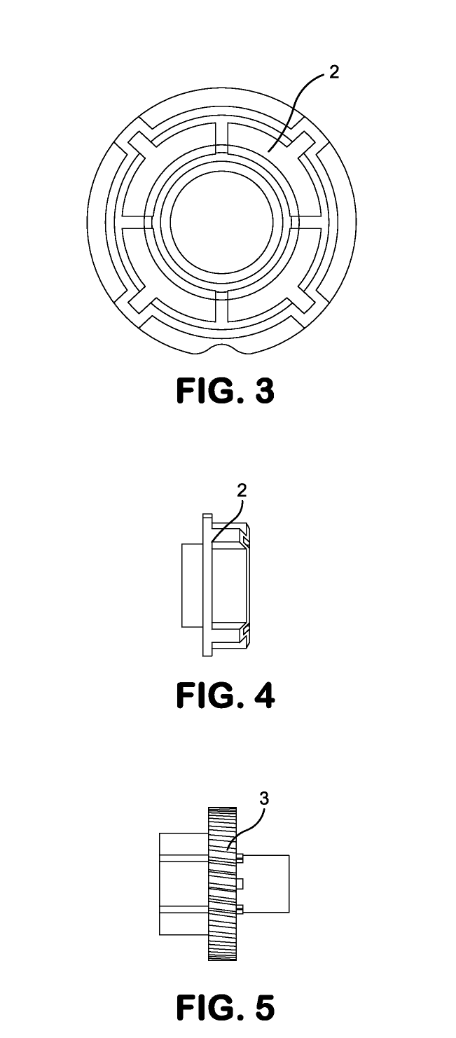

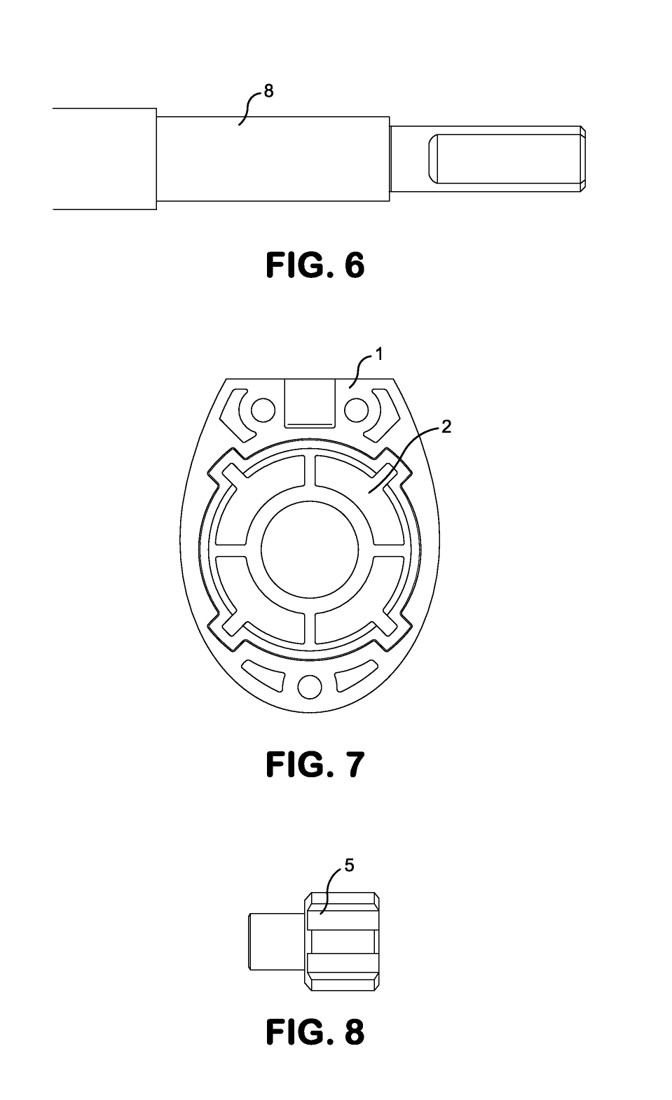

As shown in FIGS. 1 to 7, the present invention provides a bearing support device for an actuator, including a bearing support frame 1, a bearing 2, a worm wheel 3, and a spindle 8, where the bearing support frame 1 is configured to support and secure the bearing 2; the bearing 2 is configured to support the worm wheel 3 and riveted to the worm wheel 3 and the spindle 8; and the worm wheel 3 and the spindle 8 are riveted.

The bearing support frame 1 is configured to support and secure the bearing 2 so as to meet the requirement on the assembly dimensions of the bearing 2 and therefore improve the operation stability and extend the service life of the actuator system. The worm wheel and the spindle 8 are assembled and then riveted to make a sub-assembly of the worm wheel and the spindle 3, so as to increase the fit clearance between the worm wheel and the spindle 8 and make it possible for the worm wheel to deal with torque only. The bearing 2 is assembled to the riveted worm wheel 3 and spindle 8 and then installed on the bearing support frame 1, it makes it possible to support the front end and rear end of the worm wheel, so as to improve the movement stability of the actuator system and reduce noises,

In this embodiment, a bearing support frame 1 is disposed at the front end to support a hearing 2, thereby addressing a series of issues caused by the single-point support of the actuator. A 0.5 mm clearance is added between the worm wheel 3 and the spindle 8 on each side, thereby isolating the worm wheel 3 from the assembly of the spindle 8 and making it possible for the worm wheel to deal with torque only without being affected by the lateral force from the spindle 8.

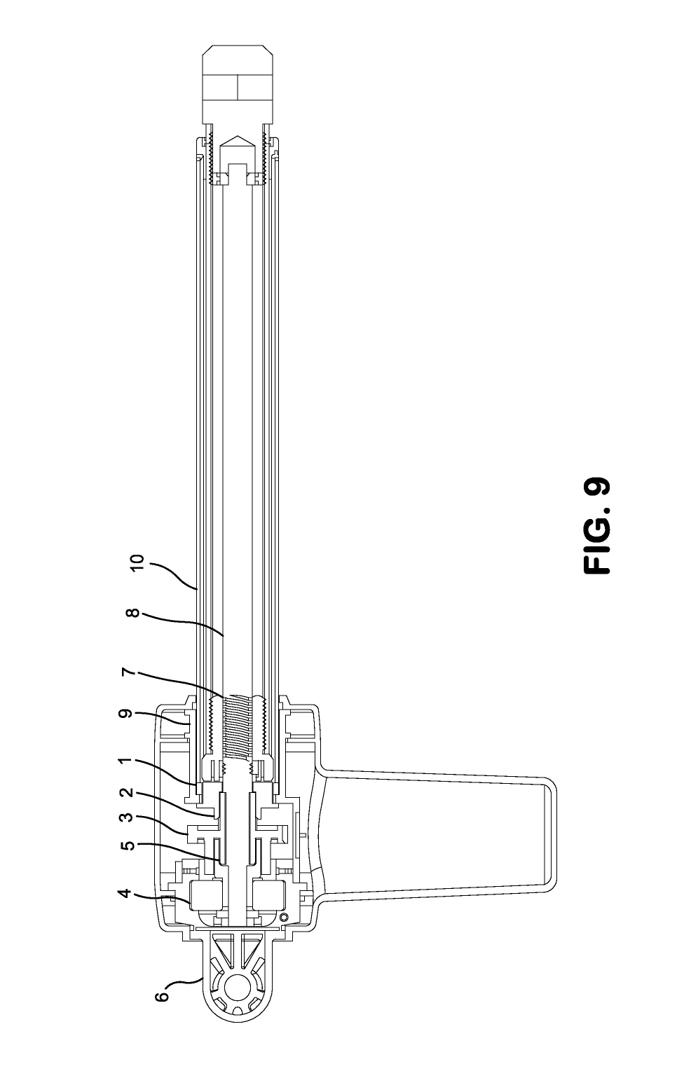

As shown in FIGS. 8 and 9, an embodiment of the invention includes a ball bearing 4, a coupling 5, a back fixture 6, a spindle nut 7, a motor housing 9, and an outer tube 10.

The bearing support frame 1 is a plastic bearing support frame that supports and secures the bearing 2 so as to meet the requirement on the assembly dimensions of the bearing 2. The bearing 2 is first installed into the motor housing 9 and then into the bearing support frame, and finally the motor housing 9 and the outer tube 10 are screwed so as to secure the bearing support frame 1. In this way, the requirement on the dimension precision is met by matching the shape of the bearing support frame 1 with the shape of the bearing 2. The bearing 2 is a plastic bearing that supports the worm wheel 3 and is riveted to the worm wheel 3, the ball bearing 4, the coupling 5, the spindle nut 7, and the spindle 8, and then installed into the motor housing 9; then the bearing 2 is guided into the bearing support frame 1.

The worm wheel 3 transfers the torque of the motor and is riveted to the spindle 8. The ball bearing 4 supports the spindle 8 and transfers the load, and is riveted to the spindle 8. The coupling 5 supports the worm wheel 3, transfers the torque of the worm wheel 3 to the spindle 8, and riveted to the spindle 8. The back fixture 6 secures the actuator to the bed frame and is installed into the ball bearing and then into the motor housing 9. The spindle nut 7 transfers linear movement and is threadingly engaged with the spindle 8. The spindle 8 provides a track for the linear movement of the spindle nut 7 and is riveted to other related parts. The motor housing 9 is a central support part for the whole movement system and is preferably screwed onto the motor. The outer tube 10 isolates the movement system from the external environment, provides a track for the movement of the spindle nut 7, and is preferably screwed onto the motor housing 9.

In this embodiment, the bearing support frame 1 and the bearing 2 work together to provide stable support for the movement of the worm wheel 3, thereby avoiding displacement and the lateral force from the spindle 8 when the spindle 8 is moving. In addition, the clearance between the spindle 8 and the worm wheel 3 increases, so that the force hearing area can be automatically optimized when the worm wheel 3 is moving.

With this structure, the same pressure is applied to all the contact surfaces of the worm wheel 3, thereby preventing breakdown due to rather high pressure on a certain contact surface; if a high lateral force is received from the spindle 8, the worm wheel 3 will not be affected because of the clearance reserved with the spindle 8, thereby ensuring the stable operation of the actuator system, reduce the noises caused by unstable operation, and extend the service life of the actuator system.

The present invention enables the actuator to run more stably and at least doubles the service life of the product; reduces the requirement of the actuator on the precision of parts such as motor housing 9 and back fixture 6 and ensures that the life of the product meet the client's requirement even when the dimension of a few parts is inaccurate; and therefore eliminates the abnormal noises generated by the spindle of the actuator.

The above descriptions are merely some exemplary embodiments of the present invention and are not intended to limit the scope of the present invention. Any equivalent shape and structure changes made without departing from the spirit and principle of the present invention shall fall within the protection scope of the present invention.

1. A linear actuator with a bearing support device, comprising a bearing support frame, a bearing, a worm wheel, and a spindle, wherein the bearing support frame is configured to support and secure the bearing, wherein the bearing is configured to support the worm wheel and riveted to the worm wheel and the spindle, and the worm wheel and the spindle are riveted.

2. The linear actuator according to claim 1, comprising a coupling that supports a worm wheel and transfers the torque of the worm wheel to the spindle, wherein the coupling is riveted to the spindle.

3. The linear actuator according to claim comprising a ball bearing that supports the spindle and transfers load, wherein the ball bearing is connected to the spindle by a rivet head.

4. The linear actuator according to claim 3, comprising a back fixture, wherein the back fixture connects to the ball bearing.

5. The linear actuator according to any one of claim 1, comprising a spindle nut which is threadingly engaged with the spindle.

6. The linear actuator according to claim 5, further comprising a motor housing which is secured onto the motor of the actuator and the bearing is installed inside the motor housing.

7. The linear actuator according to claim 6, wherein the motor housing is screwed onto the motor.

8. The linear actuator according to claim 6, wherein the back fixture connects to the motor housing.

9. The linear actuator according to claim 6, further comprising an outer tube, wherein the outer tube is secured onto the motor housing.

10. The linear actuator according to claim wherein the outer tube is screwed onto the motor housing.
